(19) United States
(12) Patent Application Publication
(10) Pub. No.: US 2013/0238682 A1
(43) Pub. Date: Sep. 12, 2013

(54) SIGNAL-EQUALIZING SYSTEM AND METHOD FOR MULTI-RATE SIGNAL

(71) Applicants: CHENG-HSIEN LEE, Tu-Cheng (TW); SHOU-KUO HSU, Tu-Cheng (TW)

(72) Inventors: CHENG-HSIEN LEE, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/527,901

(22) Filed: Jun. 20, 2012

(30) Foreign Application Priority Data
Mar. 6, 2012 (TW) 101107546

(51) Int. Cl. H04L 27/01

(52) U.S. Cl. 708/323; 375/232

(57) ABSTRACT

A signal-equalizing system for multi-rate signals and a signal-equalizing method for the system are provided. The system stores a number of compensation methods of equalization. The method includes the steps: acquiring all transmission rates of a multi-rate signal, loading output documents of a signal simulation software, wherein the output documents comprise channel loss values of all transmission rates of the multi-rate signal and selecting a compensation method based on channel loss in the course of the multi-rate signal transmitted and differences among all transmission rates of the multi-rate signal from the plurality of compensation methods of equalization.

### BACKGROUND

1. Technical Field

The disclosure relates to signal-equalizing systems and, more particularly, to a signal-equalizing system for multi-rate signal and a signal-equalizing method adapted for the system.

2. Description of Related Art

An equalizer is utilized for reducing distortion in the course of transmission of a signal. However, the equalizer compensates one single rate signal to obtain low distortion, when a multi-rate signal is transmitted, the conventional compensation method of equalization does not satisfy multi-rate signal.

Therefore, what is needed is a signal-equalizing system for multi-rate signal to overcome the described shortcoming.

### BRIEF DESCRIPTION OF THE DRAWINGS

FIG. 1 is a schematic view of a signal-equalizing system for multi-rate signal in accordance with an exemplary embodiment.

FIG. 2 is a block diagram of a control unit of the system of FIG. 1.

FIG. 3 is a flowchart of signal-equalizing method adapted for the system of FIG. 1.

### DETAILED DESCRIPTION

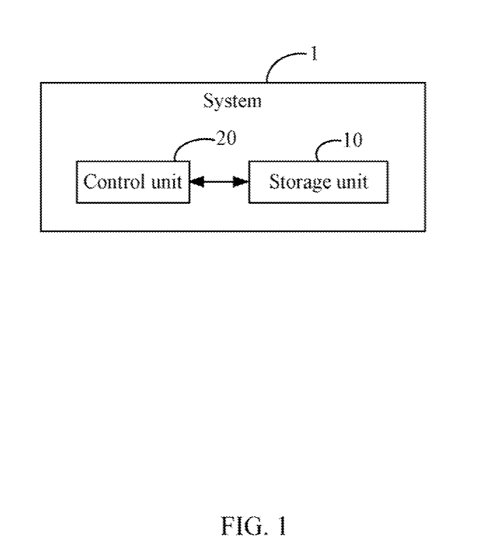

FIG. 1 is a schematic view of a signal-equalizing system for multi-rate signal in accordance with an exemplary embodiment. The signal-equalizing system for multi-rate signal (hereinafter “the system 1”) includes a storage unit 10 and a control unit 20. Each multi-rate signal can be transmitted in a number of different transmission rates.

The storage unit 10 stores the functions performed by the control unit 20. The storage unit 10 further stores a number of compensation methods of equalization and a number of groups of equalizer parameters.

In the embodiment, the number of compensation methods of equalization is equal to three, that is, an average value compensation method, a minimum value compensation method, and a maximum value compensation method. When all differences among all transmission rates of the multi-rate signal are greater than a first preset value and channel loss in the course of transmission of the multi-rate signal is greater than a second preset value, the average value compensation method is set to obtain low distortion, thereby making sure there is a reliable transmission. When all differences among all transmission rates of the multi-rate signal are greater than the first preset value and channel loss in the course of transmission of the multi-rate signal is less than the second preset value, the minimum value compensation method is set to obtain low distortion, thereby making sure there is a reliable transmission. When all differences among all transmission rates of the multi-rate signal are less than the first preset value and channel loss in the course of transmission of the multi-rate signal is less than the second preset value, the maximum value compensation method is set to obtain low distortion, thereby making sure there is a reliable transmission.

The average value compensation method is defined as compensating the transmission rate of the multi-rate signal for an average value of channel loss values of all transmission rates of the multi-rate signal. The minimum value compensation method is defined as compensating the transmission rate of the multi-rate signal for the minimum value among the channel loss values of all transmission rates of the multi-rate signal. The maximum value compensation method is defines as compensating the transmission rate of the multi-rate signal for the maximum value among the channel loss values of all transmission rates of the multi-rate signal.

Taking a formula which is well known to illustrate how to obtain a group of equalizer parameters, y(n)=a*x(n)−b*x(n−1)−c*x(n−2) . . . , wherein y(n) represents a signal amplitude value after an equalizer compensates, variable a, b, c . . . represent equalizer parameters, and x(n) represents an amplitude value of the current output signal. Each multi-rate signal defines a time period, the time period is equal to the time between transmission of the current signal and transmission of a next signal, for example, 5 seconds, thus, x(n−1) represents an amplitude value of the output signal 5 seconds ago, x(n−2) represents an amplitude value of the output signal 10 seconds ago. The output signal during each time period is compensated by the compensation method. When the group of equalizer parameters is calculated according to the formula to obtain the lowest distortion by comparing an amplitude value of the multi-rate signal before transmitting with after the equalizer compensating, the group of equalizer parameters is optimal.

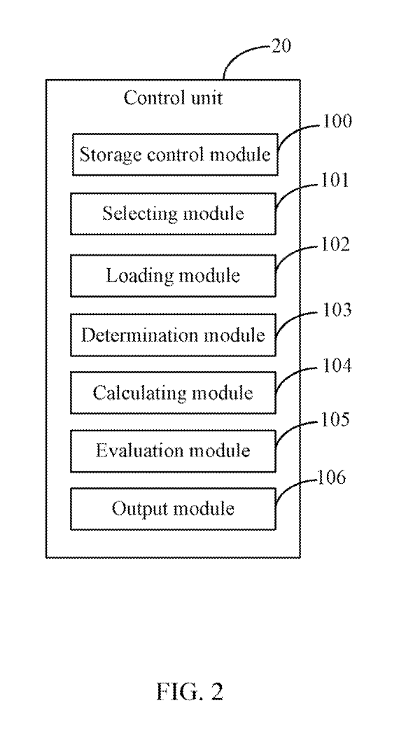

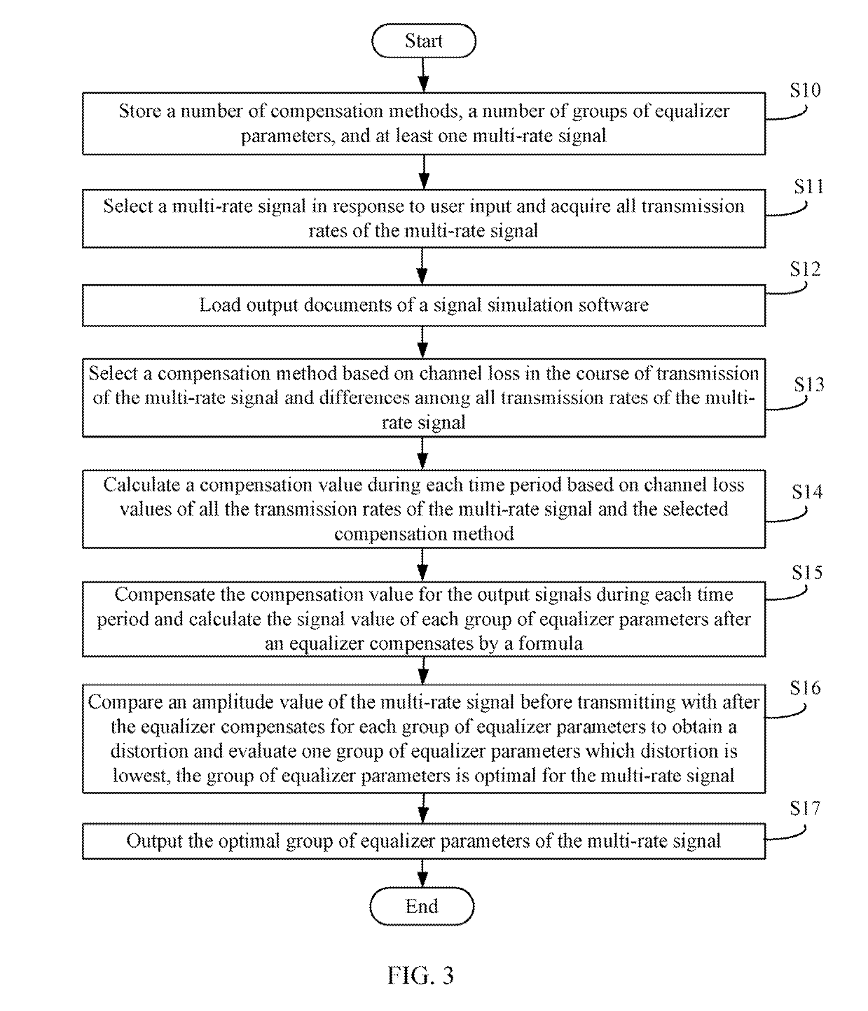

The control unit 20 is configured for controlling the system 10 to select a compensation method adapted for a current transmission of multi-rate signal from the compensation methods of equalization, calculating all the number of groups of equalizer parameters adapted for the current transmission of multi-rate signal, and acquiring one group of equalizer parameters which possesses the lowest distortion for the multi-rate signal according to calculating results. As shown in FIG. 2, the control unit 20 further includes a receiving module 100, a selecting module 101, a loading module 102, a determination module 103, a timing module 104, an evaluation module 105, and an output module 106. All modules perform corresponding functions as shown in FIG. 3.

FIG. 3 is a flowchart of signal-equalizing method adapted for the system of FIG. 1.

In step S10, the storage control module 100 stores the number of compensation methods of equalization, the number of groups of equalizer parameters, and at least one multi-rate signal. For example, the multi-rate signal is a serial attached SCSI (SAS) differential one which can be transmitted in two transmission rates, for example, 6 Gbit/s and 1.5 Gbit/s.

In step S11, the selecting module 101 selects a multi-rate signal from the at least one multi-rate signal in response to user input and acquires all transmission rates and the time period of the multi-rate signal. When the multi-rate signal is selected, the transmission rates and the time period of the multi-rate signal are correspondingly generated. The multi-rate signal may be a SAS one or a SATA one. If the storage control module 100 stores a multi-rate signal, the procedure does not perform the step by the selecting module 101.

In step S12, the loading module 102 loads output documents of a signal simulation software, wherein the output documents include the amplitude values of output signals during each time period and channel loss values of all transmission rates of the multi-rate signal, and the signal simulation software is used to simulate and analyze signal transmission of to obtain the amplitude values of output signals during each time period.

In step S13, the determination module 103 selects a compensation method based on channel loss in the course of the multi-rate signal transmitted and differences among all transmission rates of the multi-rate signal from the number of compensation methods of equalization.

In step S14, the calculating module 104 calculates a compensation value during each time period based on channel loss values of all transmission rates of the multi-rate signal and the selected compensation method. For example, the multi-rate signal is a SAS differential one which includes two transmission rates, for example, 6 Gbit/s and 1.5 Gbit/s, when the SAS differential signal is transmitted via 6 Gbit/s, the channel loss value is 9 dB, and when the SAS differential signal is transmitted via 1.5 Gbit/s, the channel loss value is 3 dB. The determination module 103 selects the average value compensation method based on the channel loss values of the SAS differential signal and differences between the two rates, and the calculating module 104 calculates the compensation value during each time period which is equal to 6 dB((9+3)/2).

In step S15, the calculating module 104 further compensates the compensation value for the output signals during each time period and calculates the signal amplitude values of all the number of groups of equalizer parameters after the equalizer compensates by the formula.

In step S16, the evaluation module 105 compares an amplitude value of the multi-rate signal before transmitting with after the equalizer compensates for each group of equalizer parameters to obtain a distortion and evaluates one group of equalizer parameters which distortion is lowest, the group of equalizer parameters is optimal for the multi-rate signal.

In step S17, the output module 106 outputs the optimal group of equalizer parameters of the multi-rate signal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A signal-equalizing system for multi-rate signal, the system comprising:
a storage unit to store a plurality of compensation methods of equalization; and
a control unit comprising:
a selecting module to acquire all transmission rates of a multi-rate signal;
a loading module to load output documents of a signal simulation software, wherein the output documents comprise channel loss values of all transmission rates of the multi-rate signal; and
a determination module to select a compensation method based on channel loss in the course of the multi-rate signal transmitted and differences among all transmission rates of the multi-rate signal from the plurality of compensation methods of equalization.

2. The system as recited in claim 1, wherein the multi-rate signal defines a time period and the output documents further comprise amplitude values of output signals during each time period, the storage unit is further configured to store a plurality of groups of equalizer parameters, the system further comprises:
a calculating module to calculate a compensation value during each time period based on channel loss values of all transmission rates of the multi-rate signal and the selected compensation method, compensate the compensation value for the output signals during each time period and calculate the signal amplitude values of all the plurality of groups of equalizer parameters after an equalizer compensates by a formula; and
an evaluation module to compare an amplitude value of the multi-rate signal before transmitting with after the equalizer compensates for each group of equalizer parameters to obtain a distortion and evaluate one group of equalizer parameters which distortion is lowest, wherein the group of equalizer parameters is optimal for the multi-rate signal, and the output module to output the optimal group of equalizer parameters of the multi-rate signal.

3. The system as recited in claim 2, wherein the formula is y(n)=a*x(n)−b*x(n−1)−c*x(n−2) . . . , y(n) represents a signal amplitude value after an equalizer compensates and variable a, b, c . . . represent equalizer parameters, x(n) represents an amplitude value of the current output signal, x(n−1) represents an amplitude value of the output signal the first time period ago, x(n−2) represents an amplitude value of the output signal the second time period ago ago . . . , and the output signal during each time period is compensated by the compensation method.

4. The system as recited in claim 1, wherein the number of compensation methods of equalization is three, that is, an average value compensation method, a minimum value compensation method, and a maximum value compensation method, when all differences among all transmission rates of the multi-rate signal are greater than a first preset value and channel loss in the course of transmitting the multi-rate signal is greater than a second preset value, the average value compensation method is set, when all differences among all transmission rates of the multi-rate signal are greater than the first preset value and channel loss in the course of transmission of the multi-rate signal is less than the second preset value, the minimum value compensation method is set, and when all differences among all transmission rates of the multi-rate signal are less than the first preset value and channel loss in the course of transmission of the multi-rate signal is less than the second preset value, the maximum value compensation method is set.

5. The system as recited in claim 4, wherein the average value compensation method is a compensation one for an average value of channel loss values of all transmission rates of the multi-rate signal, the minimum value compensation method is a compensation one for the minimum value among the channel loss values of all transmission rates of the multi-rate signal, and the maximum value compensation method is a compensation one for the maximum value among the channel loss values of all transmission rates of the multi-rate signal.

6. A signal-equalizing method for a system, wherein the system stores a plurality of compensation methods of equalization, the method comprising:
acquiring all transmission rates of a multi-rate signal;
loading output documents of a signal simulation software, wherein the output documents comprise channel loss values of all transmission rates of the multi-rate signal; and
selecting a compensation method based on channel loss in the course of the multi-rate signal transmitted and differences among all transmission rates of the multi-rate signal from the plurality of compensation methods of equalization.

7. The method as recited in claim 6, wherein the multi-rate signal defines a time period and the output documents further comprise amplitude values of output signals during each time period, the system further stores a plurality of groups of equalizer parameters, the method further comprises:
calculating a compensation value during each time period based on channel loss values of all transmission rates of the multi-rate signal and the selected compensation method, compensating the compensation value for the output signals during each time period and calculating the signal amplitude values of all the plurality of groups of equalizer parameters after an equalizer compensates by a formula; and
comparing an amplitude value of the multi-rate signal before transmitting with after the equalizer compensates for each group of equalizer parameters to obtain a distortion and evaluate one group of equalizer parameters which distortion is lowest, wherein the group of equalizer parameters is optimal for the multi-rate signal, and outputting the optimal group of equalizer parameters of the multi-rate signal.

8. The method as recited in claim 7, wherein the formula is y(n)=a*x(n)−b*x(n−1)−c*x(n−2) . . . , y(n) represents a signal amplitude value after an equalizer compensates and variable a, b, c . . . represent equalizer parameters, x(n) represents an amplitude value of the current output signal, x(n−1) represents an amplitude value of the output signal the first time period ago, x(n−2) represents an amplitude value of the output signal the second time period ago . . . , and the output signal during each time period is compensated by the compensation method.

9. The method as recited in claim 6, wherein the number of compensation methods of equalization is three, that is, an average value compensation method, a minimum value compensation method, and a maximum value compensation method, when all differences among all transmission rates of the multi-rate signal are greater than a first preset value and channel loss in the course of transmission of the multi-rate signal is greater than a second preset value, the average value compensation method is set, when all differences among all transmission rates of the multi-rate signal are greater than the first preset value and channel loss in the course of transmission of the multi-rate signal is less than the second preset value, the minimum value compensation method is set, and when all differences among all transmission rates of the multi-rate signal are less than the first preset value and channel loss in the course of transmission of the multi-rate signal is less than the second preset value, the maximum value compensation method is set.

10. The method as recited in claim 6, wherein the average value compensation method is a compensation one for an average value of channel loss values of all transmission rates of the multi-rate signal, the minimum value compensation method is a compensation one for the minimum value among the channel loss values of all transmission rates of the multi-rate signal, and the maximum value compensation method is a compensation one for the maximum value among the channel loss values of all transmission rates of the multi-rate signal.
